(19) United States
(12) Patent Application Publication
(10) Pub. No.: US 2015/0132060 A1
(43) Pub. Date: May 14, 2015

(54) RAPID DEPLOYMENT EROSION CONTROL GRASS STRIP WITH INTEGRATED HYDRATION, NUTRITION, AND MULCH SYSTEMS

(71) Applicant: ROOTS SOLUTIONS, LLC, Santa Rosa, CA (US)

(72) Inventor: Stefan W. Stehling, Santa Rosa, CA (US)

(73) Assignee: ROOTS SOLUTIONS, LLC, Santa Rosa, CA (US)

(21) Appl. No.: 14/533,860

(22) Filed: Nov. 5, 2014

Related U.S. Application Data
(60) Provisional application No. 61/902,071, filed on Nov. 8, 2013.

(51) Int. Cl. E02D 17/20; A01G 27/02; E02B 3/04; E02B 13/02; E02B 3/12

(52) U.S. Cl. CPC E02D 17/202; E02B 13/02; E02B 3/127; E02B 3/04; E02B 3/125; A01G 27/02
USPC 405/15; 405/302.6; 405/36

(57) ABSTRACT

A rapid deployment integrated erosion prevention and soil stabilization system that eliminates the need to disturb the soil by digging, tilling, trenching, or soil void formation, said system that includes an irrigation bladder with a plurality of water outlets; an elongate mulch wattle spaced slightly apart from said bladder and disposed in a generally parallel side-by-side relationship in relation to said bladder; and a generally linear array of deep rooting plant strips disposed between said bladder and said wattle; wherein said irrigation bladder, said mulch wattle and said grass strips are physically combined to form a deployment module.

### CROSS REFERENCES TO RELATED APPLICATIONS

The present application claims the benefit of the filing date of U.S. Provisional Patent Application Ser. No. 61/902,071, filed Nov. 8, 2013, which is incorporated in its entirety by reference herein.

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION BY REFERENCE OF MATERIAL SUBMITTED ON A COMPACT DISC

Not applicable.

### BACKGROUND OF THE INVENTION

1. Field of the Invention

The present invention relates generally to methods and apparatus for rapidly establishing plants in soil, and more particularly to a method and apparatus for rapidly establishing and deeply rooting a linear array of soil anchoring vegetation and ecologically restorative biota without the need to dig, trench, create soil voids, or otherwise disturb the soil structure or profile, and still more particularly to a method and apparatus for rapid deployment erosion control and soil stabilization using arrays of deep rooting plant strips, such as anchor grasses, and having an integrated hydration and mulch system, including protection from burrowing animals.

2. Background Discussion

Soil erosion and soil pollution are longstanding problems that have motivated countless proposed solutions. Soil erosion is caused naturally by weather, ordinary physical processes, such as rainfall and surface runoff, tidal erosion, flooding and freezes, wind, and so forth; by animal impact; and by human disturbances, such as agriculture, deforestation, and road construction. Soil pollution may result from naturally occurring deposits of heavy metals and other chemicals or through human caused contamination from organic and non-organic sources (septic systems, concentrated livestock manure, or mine tailings containing lead or other contaminants). Construction projects routinely involve ground clearing (vegetation removal) and grading activities that adversely impact soils in and around the construction sites, and disturbed soils have increased erosion rates in relation to a previously undisturbed site. Accordingly, the construction industry has long been engaged in an effort to minimize the scale of soil disturbed on construction sites and to prevent continued erosion during and after construction activities have ceased.

It is widely known that vegetation is a highly effective way to control erosion and to provide soil stabilization. Vegetation reduces the mechanical effects of wind erosion and impact from falling rain, thereby reducing redistribution of particulate soils and runoff; it disperses and reduces surface water velocity; it provides mechanical restraints (roots) to soil movement; it enhances water infiltration by improving soil structure and increasing the soil porosity through roots and plant residues; and it actively transpires water up and out from soils, reducing soil moisture content and increasing soil moisture storage capacity, through an increase of the carbon content of the soil—notably in the formation of humus; thereby sequestering atmospheric carbon into plant bodies and soil.

Nonvegetative means for preventing erosion and enhancing soil stabilization are also well known. These include such things as the use of fiber rolls (for temporary control), mulch, stone aggregate and riprap (including caged riprap or gabions), retaining walls, and so forth. These protect disturbed ground from erosion in much the same fashion as vegetative means, with the exception that they do not much enhance soil porosity or provide transpiration to pull water off the ground surface, or increase the carbon content of the soil thereby not increasing soil fertility or sequestering any atmospheric carbon, but instead contribute to carbon loading of the atmosphere by requiring heavy equipment use for the procurement and installation of such means.

A known system for soil and water conservation is promoted by Vetiver Network International (www.vetiver.org) and goes by the name of “The Vetiver System.” The system is used for soil erosion control, slope protection, prevention and treatment of contaminated water, levees and sea dike stabilization, and so forth, and involves the use of clones of vetiver (Chrysopogon zizanioides), a non-fertile, noninvasive Indian clump grass. It is generally installed in narrow linear strips or hedgerows, wherein its 2-4 meter deep roots hold soil in place and dense ground-level stems restrain sediment flows. The roots have demonstrated 75 MPa tensile strength, so it improves the shear strength of soils by as much as 40%.

Known methods roadside re-vegetation include hydroseeding applications of native seed mixes for grasses, forbs, shrubs, and trees; “expandable stinger” equipment and deep-rooted stocktypes to establish seedlings on previously inaccessible slopes; and seed mat methods to establish plants on vertical gabion walls.

The USFS, WFLHD, and private sector cooperators hope to continue to develop new re-vegetation strategies, stocktypes, and technologies in this effort. One challenge of this field is a lack of practical information regarding species and strategies for effective re-vegetation.

Many improvements in the field of vegetative soil erosion techniques have been proposed in recent years. For instance, U.S. Pat. No. 8,230,643, to Chang, discloses a slope planting structure that includes containing bags laid on the surface of a slope, stuffing filled in the containing bags, and fasteners. The containing bags are provided with plant seeds. The stuffing comprises plant growing material and absorbent material is filled into the containing bags. The containing bags are laid on the surface of the slope, and then the fasteners are inserted through the containing bags to secure the containing bags on the slope. The containing bags are integrated with the slope to secure the slope.

U.S. Pat. No. 7,992,344, to Kim, describes an artificial soil and a method for growing vegetation on a sloped surface. The artificial soil is produced by mixing peat or grass peat, paper chip or pulp chip, saw dust or bark, fermented animal waste or dried animal waste, and a microbe activator, frisol; and by adding clay or silt granules to the mixture. The method comprises forming a vegetation base layer by applying the artificial soil to a sloped surface; waiting until the vegetation base layer has a crack by a shrinkage; and applying a seed mixture of artificial soil over the vegetation base layer, the seed mixture of artificial soil obtained by adding a myocardium catalyst, a microbe activator, a material binder, an evaporation prevention material, and grass seeds, weed seeds, and tree seeds to the artificial soil with water.

While not directed to a method for erosion control, U.S. Pat. No. 5,921,020, to Avidan, modestly gestures conceptually in the direction of the present invention by teaching a method for producing a ready-to-plant live fence unit. To implement the method, an elongate container containing a growing medium is provided. Plants are planted in the elongate container arrayed along the longitudinal dimension. The plants are cultivated such that they grow in an interlocked manner to a substantially uniform approximate desired height so as to form a ready-to-plant live fence unit.

Likewise, U.S. Pat. No. 5,561,947, to Greenarch, shows an improved method of transplanting hedges and/or trees. The method involves the use of a V-shaped crate for a plant, hedge or tree that includes members holding slidably removable side panels extending between the end members. The side panels are slidably received in the end members, in a manner which enables the side panels to be removed from the end members by pulling the side panels in their respective upwardly diverging directions. After plants are cultivated to a sufficient state of maturity, the crate is placed in a hole, and the side panels, and then the end panels, are removed. The root ball is thereby minimally disturbed.

The foregoing patents, patent applications, and known commercial systems, reflect the current state of the art of which the present inventor is aware. Reference to, and discussion of, these patents is intended to aid in discharging Applicant's acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein.

Further, despite the many recent improvements in the field suggested by the foregoing documents, there is ample room for improvements that provide the many advantages of the present invention. Most pertinently, there is room for improvement of The Vetiver System and similar deployment systems for restorative vegetation by providing a means for rapidly deploying the anchoring grass and not disturbing the soil or requiring any digging, trenching, or void creation within the soil profile, while maximizing soil water retention through mulched sides and the elimination of competing weeds (and optionally seeding a succession generation of customized native species), and for providing in situ hydration and nutrition systems that minimize the need to tend or to cultivate the plants to maturity.

### BRIEF SUMMARY OF THE INVENTION

The present invention is an integrated Vetiver grass erosion prevention and soil stabilization system that may be prepared for rapid deployment and extremely high success rather of establishment at a construction site or other site in need of erosion control, and/or re-vegetation of degraded land without need for soil disturbance (digging, trenching or other soil void formation).

It is thus a principal object of the present invention to provide a new and improved rapid deployment anchor grass strip that prevents erosion and stabilizes soils.

Another object of the present invention to provide a rapid deployment deep rooting plant strip that includes both a hydration system and a mulch system that are structurally incorporated into the system. Optionally, a protective strip of metal mesh may be added to protect the plants from gopher of mole damage.

A further object or feature of the present invention is to provide a rapid deployment anchor grass strip that filters storm and other water runoff and thereby protects nearby waterways.

A still further object of the present invention is to provide a rapid deployment anchor grass strip that increases rainwater and other water infiltration into the soil.

Yet another object of the present invention is to provide a rapid deployment deep rooting plant strip that remediates soil toxins.

Another object of the present invention is to provide a rapid deployment anchor grass strip that can remove organic and inorganic pollutants including antibiotics from waste water.

A further object of the present invention is to provide a rapid deployment anchor grass strip that restores and promotes soil fertility.

A still further object of the present invention is to provide a rapid deployment anchor grass strip that can function as a weed barrier (from below soil level weed root travel and above ground seed dispersal) and wind barrier.

A continuing object of the present invention is to provide a rapid deployment anchor grass strip that can be used for simple landscape purposes.

Yet, another object of the present invention is to provide a rapid deployment deep rooting plant strip that is non-invasive, browse tolerant, drought and flood tolerant, and salt and pH tolerant.

Another object of the present invention is to provide a rapid deployment anchor grass strip that provides a locally grown solution including very low embodied energy and sequesters atmospheric carbon.

Yet a still further object of the present invention is to provide a rapid deployment deep rooting plant strip that provides deep, penetrating vertical roots with a tensile strength ⅙^{th} that of steel, equal to or greater than many hardwood species.

Other potentially advantageous uses include use as windbreaks, wildlife habitat and as self-limiting pioneer species, providing host conditions for native plant succession and re-vegetation, and for multiple types of phyto-remediation (mine tailings, contaminated water runoff, leach field effluent from septic systems, etc.) The invention is especially useful in remote areas with limited access to water and where there is a need for low maintenance weeding, plant replacement, and so forth.

The present invention achieves the foregoing objects and advantages by providing a system and method for rapidly deploying and planting a row of vetiver (anchor) grass with ready-to-use and built in mulching, irrigation, and plant nutrition subsystems.

The foregoing summary broadly sets out the more important features of the present invention so that the detailed description that follows may be better understood, and so that the present contributions to the art may be better appreciated. There are additional features of the invention that will be described in the detailed description of the preferred embodiments of the invention which will form the subject matter of the claims appended hereto.

Accordingly, before explaining the preferred embodiment of the disclosure in detail, it is to be understood that the disclosure is not limited in its application to the details of the construction and the arrangements set forth in the following description or illustrated in the drawings. The inventive apparatus described herein is capable of other embodiments and of being practiced and carried out in various ways. For a better understanding of the present invention, its advantages and the specific objects attained by its uses, reference should be made to the accompanying drawings and descriptive matter in which there are illustrated the preferred embodiments.

### BRIEF DESCRIPTION OF SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is an upper perspective view showing the inventive rapid deployment erosion control deep rooting plant strip with integrated hydration, nutrition, and mulch systems, shown installed and deployed on a sloping hillside;

FIG. 2 is a cross-sectional side view in elevation thereof;

FIG. 3A is a cross-sectional end view of the system showing the structural elements in the process of assembly;

FIG. 3B is a cross-sectional end view showing the structural elements assembled;

FIG. 3C is the same view showing anchor grass installed in conjunction with the system, with the grass rooted in a growing media root ball mass;

FIG. 4A is a cross-sectional end view showing an alternative embodiment with an irrigation bladder surrounded by mulch material;

FIG. 4B is a cross-sectional end view of another alternative embodiment showing the use of two, rather than one, uphill irrigation bladders;

FIG. 5A is a top plan view of an installation showing the first preferred embodiment, as shown in FIG. 3B, with modules shown combined in an end-to-end arrangement; and

FIG. 5B is a top plan view showing yet another embodiment with double-wide modules combined in an end-to-end arrangement.

### DETAILED DESCRIPTION OF THE INVENTION

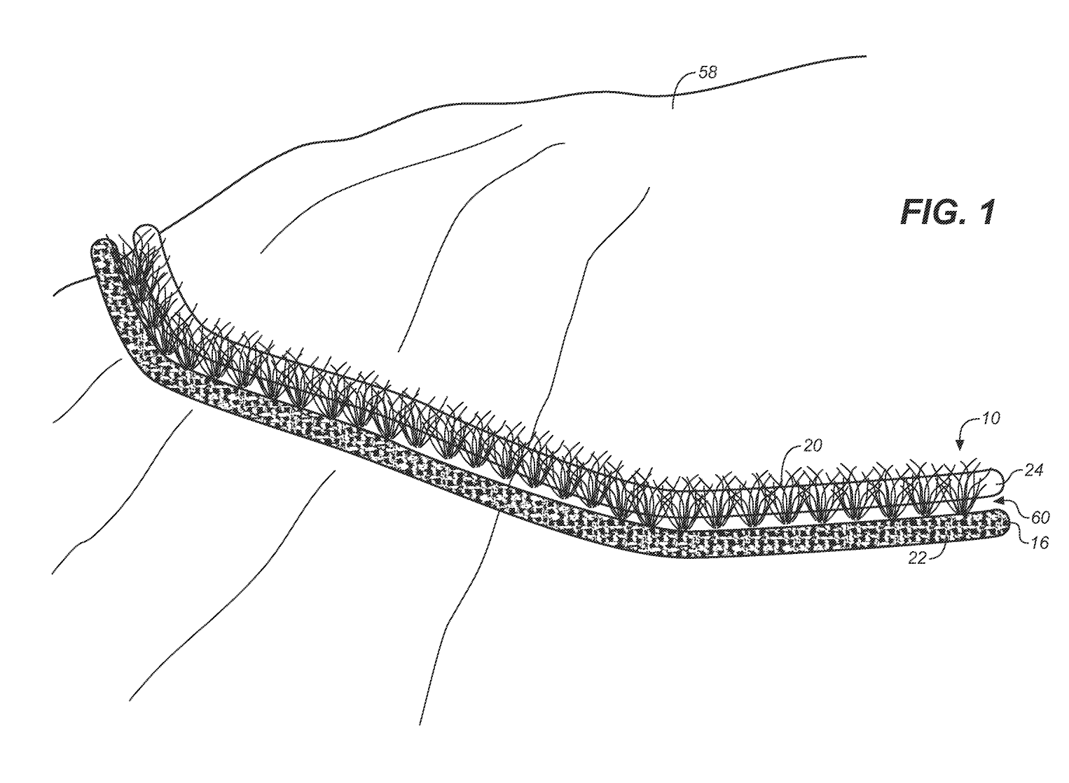

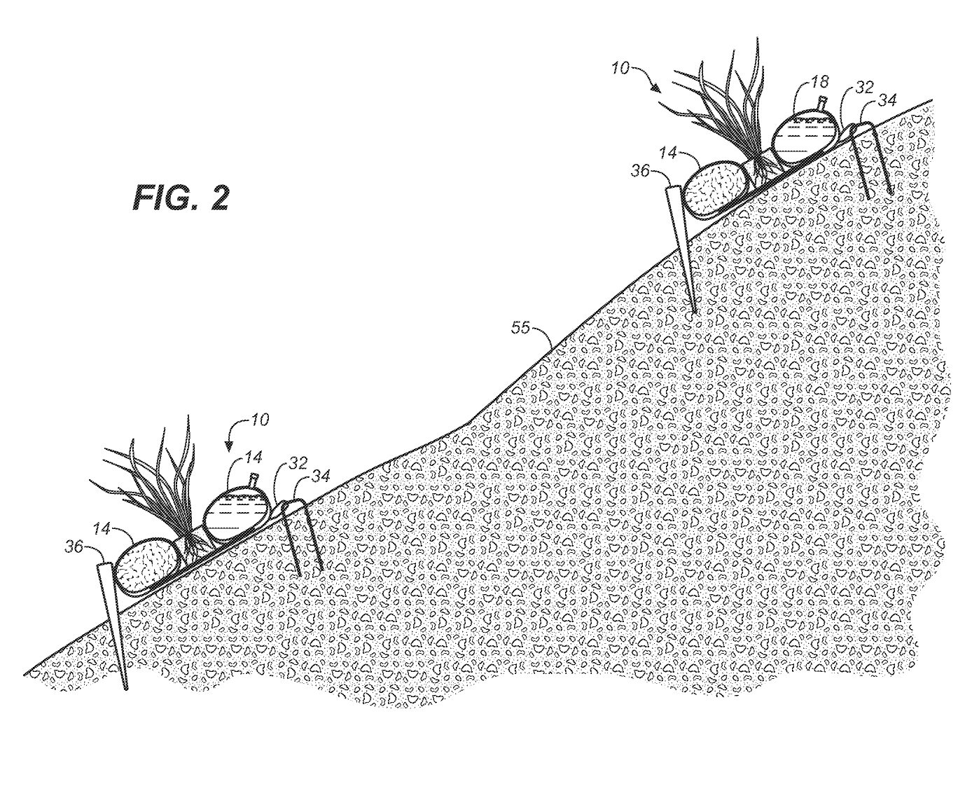

Referring to FIGS. 1 through 5B, wherein like reference numerals refer to like components in the various views, there is illustrated therein an anchor grass strip with integrated hydration, mulching, and nutrition systems, the combination generally denominated 10 herein. These views, collectively, show that the inventive system comprises an elongate biodegradable fabric panel 12 rolled on a first longitudinal side 14 into a first generally cylindrical roll or sleeve 16, and on a second longitudinal side 18 into a second generally cylindrical roll or sleeve 20. In the preferred embodiments, the first roll 16 is a cylindrical wattle containing a composting mulch 22. The second roll 20 contains and surrounds an elongate permeable (e.g., micro-perforated) irrigation bladder composed of a biodegradable plastic 24 having at least one water inlet 26 or valve. In most hillside installations, as shown in FIGS. 1-2, the mulch wattle functions as the downhill roll, wherein the mulch will slowly compost into the hillside soil and provide organic material for plant nutrition and for optimal root development; and the irrigation bladder functions as an uphill water source, such that water very slowly seeps out from the bladder at a generally constant rate over a sufficiently long period of time to ensure deep rooting. This permits optimal water usage and allows for plant establishment in harsh or climactically non-optimal conditions in remote areas without access to water, thereby reducing the need and/or frequency of water delivery to and water storage at the site.

Various combinations of mulch wattle and irrigation bladder are generally shown in the attached drawings. These uphill and downhill elements are generally evenly or substantially evenly spaced apart so as to maintain a kind of parallel relationship to one another along the contour lines of a slope. Preferably, the uphill irrigation bladder and the downhill mulch wattle sleeves are formed from a common panel of netting, burlap, excelsior fiber, or other biodegradable fiber 12, from which both the mulch wattle and irrigation bladder sleeve are formed.

When called for, a panel of metal or plastic or natural material in grid, woven or non-regular configuration (commonly known as hardware cloth, or gopher wire) 28 can be disposed immediately above the unrolled flat portion 30 of the fabric panel for the purpose of preventing plant damage from burrowing mammals.

As will be appreciated, and referring now particularly at FIGS. 1 and 2, the wattles are adapted for installation along the contours of a sloped surface SS; accordingly, fabric loops 32 are provided on the uphill sleeve for securing to uphill anchors 34, and retention stakes 36 are provided to secure the downhill mulch wattles 16, from the downhill side.

As noted, the downhill mulch wattles 16 are stuffed or filled with a biologically based mulch 22 of some kind, preferably straw or grass, or more preferably from the cut stems and blades of the Chrysopogon zizanioides (also known as vetiver, and thus referred to variously herein as “vetiver” and/or “anchor grass”), from which the deep rooting anchor grass strips are made. The mulch stuffing may be seeded with micro-organisms to facilitate nutrient release and/or customized native seed blends for succession planting.

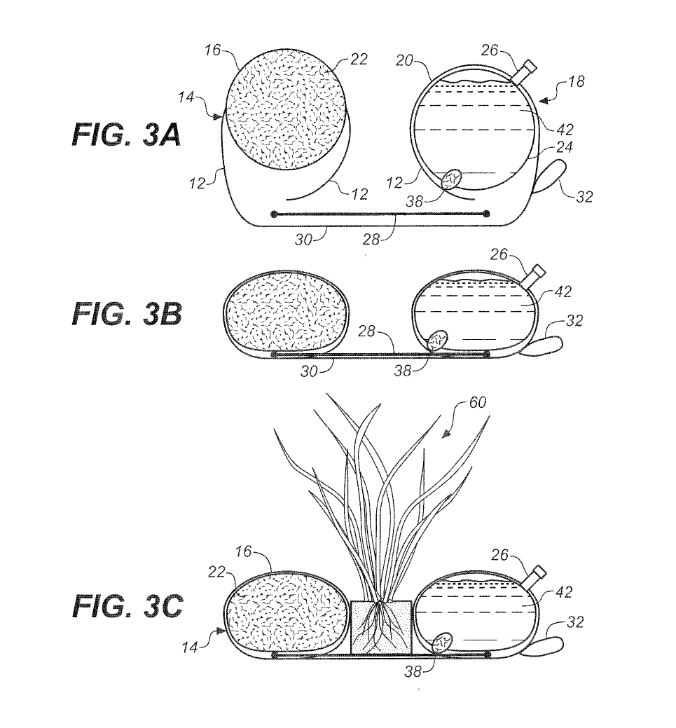

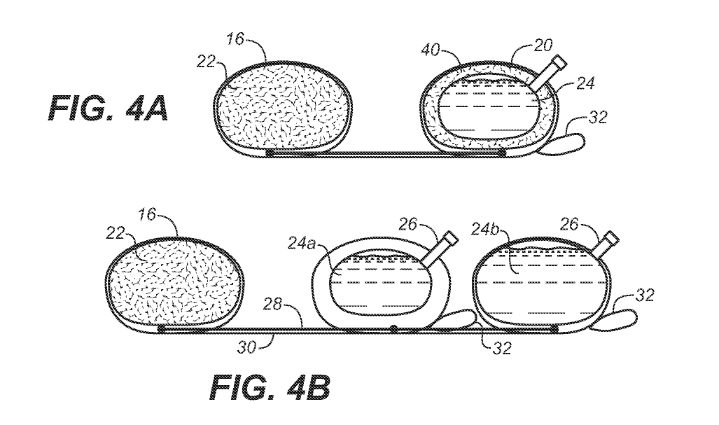

Looking next at FIG. 4A, the uphill sleeve or roll 20 may also be stuffed, at least partially, with a biologically based mulch 40, possibly in a configuration in which the mulch generally wraps or surrounds the bladder. In the preferred embodiments, at least a portion of the uphill wattle includes an elongate, tubular, permeable irrigation bladder 24 as well as a slow release nutrient tube 38. The nutrient tube may be disposed either on the inside of the uphill sleeve or affixed lengthwise along the outside of the sleeve, though it is preferable that the nutrient tube be positioned on the inside of the uphill sleeve, closest to the plant, as depicted in FIGS. 3A-3C. Further, it preferably comprises a dried and pressed nutrient vermicompost formed into a nutrient rope. In the alternative, the irrigation bladder may itself be filled with a plant nutrient solution. Yet another alternative is to provide a nutrient sheet (not shown) underneath the bladder and over the fabric sheet.

The irrigation bladder 24 preferably comprises a biodegradable single or multilayer of permeable film that contains a volume of water 42 or a supply of water so as to ensure a slow but steady release of water through the micro-perforations or other permeability feature that will migrate to or trickle down and over the nutrient rope so as to release its nutrients into the soil underneath the wattles. If durability is sought, several more layers of film may be provided to form the bladder. Likewise, if ample irrigation is called for, a second irrigation bladder 24a/b can be disposed either outside or inside the most uphill bladder 24a/b. [See FIG. 4B]

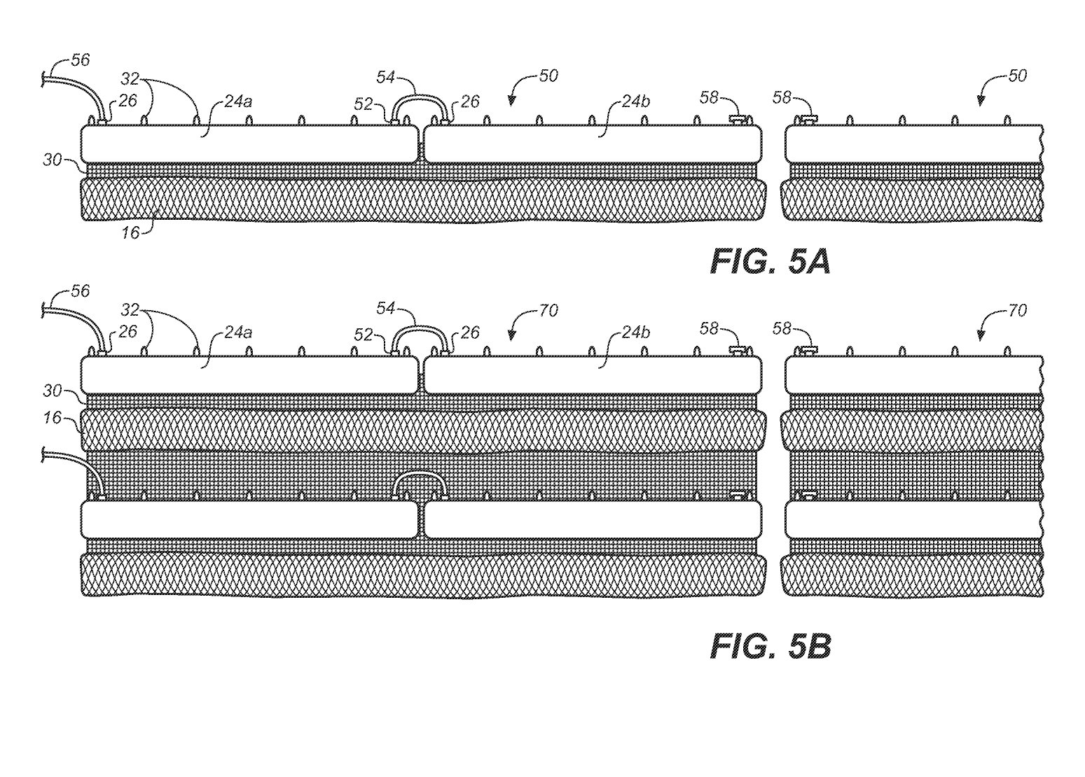

As will be appreciated, the wattle and irrigation bladder are not of indefinite length, but each has a predetermined longitudinal dimension, such that the combination of fabric panel 12, downhill mulch wattle 16 and uphill bladder and sleeve 24/20 form a deployment module 50, as best seen by reference to FIG. 5A. Each module may include one or more irrigation bladders 24, each having at least a water inlet or fill tube 26 or valve on each bladder segment 24a, 24b, and preferably an outlet tube 54a/54b, such that adjoining bladders may be bridged with a jumper hose 56, so that filling can be achieved through a supply hose 56 at the end of a length of joined segments. A cap 58 terminates the fluid path at the path end or at any point desired.

In a preferred embodiment, the wattles are each approximately 6-12 inches in diameter, and also preferably are elliptical or oval in shape, with the long axis of symmetry disposed generally in a horizontal orientation. A space of about 2-4 inches separates the downhill mulch wattle and the uphill irrigation bladder or bladder/wattle combination, creating a kind of “mulch cradle” for placement of the anchor grass 60. The portion 30 of fabric panel 12 joining the wattle and bladder sleeves, possibly in conjunction with gopher wire 28 will prevent pest destruction of the plants before they are well established.

FIG. 5B shows deployment modules 70 comprising side-by-side wattle/irrigation bladder combinations. The functional elements are otherwise identical to those already described.

In most installations, there will be a plurality of deployment modules laid out linearly in an end-to-end relationship along a hillside or slope, and such an installation is contemplated herein. Thus, the system is discussed in terms of plural modules.

Preliminary to installation, a hedge or strip of a deep rooting plant, such as anchor grass 60, is formed in a greenhouse or nursery. A plurality of tillers or slips (2-5 tillers connected) of anchor grass is planted in a growing medium contained in a linear planter, preferably a longitudinally cut pipe or another kind of elongate channel of variable dimensions an example of which might be 2″-4″×2″-4″×4′. A screen or netting may be placed in the base of the channel so as to promote root cohesion and interconnection, but after a short period of growing time—60-180 days—root development is sufficient for harvesting and transplant. The now fully connected strip (via an integrated root mass) is removed from the channel and ready for deployment.

In the alternative, the anchor grass (or other deep rooting plant) is either initially cultivated or disposed in a contained root ball in soil or another growth medium (see FIG. 3C). In this way, the anchor grass root ball can be placed on the mulch cradle and allowed to root into the soil in situ after deployment. It will be appreciated that the root ball can itself be configured, shaped, and sized to meet the anticipated site conditions, the spacing between the uphill and downhill wattles, and the like.

After harvesting the anchor grass strips are shipped to the installation site for transplantation in the mulch cradles. At the site a plurality of wattle/hydration/nutrition system units may be preplaced in one or several rows. The anchor grass strips are placed between uphill and downhill wattles so as to be captured by and retained by the wattles. They are then watered in and thereafter left to grow in place without tending through the provision of water and nutrients from the uphill wattle/irrigation bladder, and nutrient tube or solution.

Deployment can be facilitated by pre-forming large blocks or segments of wattle, gopher wire, unfilled irrigation bladder and nutrient tube assemblies. Alternatively, long assemblies can be disposed on large spools or reels and paid out onsite onto the ground. The anchor grass is placed only after deployment of the wattles, fabric connector, and wire, though a fully integrated system, including pre-placed anchor grass, is also contemplated.

In an alternative embodiment, rather than incorporating an irrigation tube in the uphill sleeve, the uphill sleeve may instead be filled with straw or grass (i.e., it may be made into a wattle), and a drip tube may be disposed atop the wattle. Water released from the drip tube will migrate through the wattle fill material and will dissolve nutrients in a nutrient rope placed underneath the drip tube, either low within the wattle or even under the wattle.

In another alternative embodiment, the anchor grass strips are placed in the mulch cradle before deployment in the field. They are then transported as a complete unit or modular assembly, comprising the uphill and downhill sleeves/wattles, the uphill sleeve including an empty irrigation bladder (which will be filed on deployment), and optional nutrient ropes and gopher wire. After staking the wattles, the micro-perforated irrigation bladder is filled from a water source and left to discharge over a prolonged period, sufficient for the anchor grass to root. There is thus provided a method of rapidly deploying segments or lengths of the wattle/anchor grass units and installing them intact to create a rapidly growing transplanted hedgerow.

From the foregoing, it will be appreciated that the inventive system, in its most essential aspect, is a rapid deployment integrated grass erosion prevention and soil stabilization system, through viability enhancing, biologically based re-vegetation, that eliminates the need to disturb the soil by digging, tilling, trenching, or soil void formation, the system comprising: an irrigation bladder with a plurality of water outlets; an elongate mulch wattle spaced slightly apart from the bladder and disposed in a generally parallel side-by-side relationship in relation to the bladder; and a generally linear array of grass strips disposed between the bladder and the wattle; wherein the irrigation bladder, the mulch wattle and the grass strips are physically combined to form a deployment module.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A rapid deployment integrated erosion prevention and soil stabilization system that eliminates the need to disturb the soil by digging, tilling, trenching, or soil void formation, said system comprising:
an irrigation bladder with a plurality of water outlets;
an elongate mulch wattle spaced slightly apart from said bladder and disposed in a generally parallel side-by-side relationship in relation to said bladder; and
a generally linear array of deep rooting plant strips disposed between said bladder and said wattle;
wherein said irrigation bladder, said mulch wattle and said plant strips are physically combined to form a deployment module.

2. The system of claim 1, wherein said water-containing bladder is a permeable bladder.

3. The system of claim 1, further including a structurally integrated plant nutrition subsystem.

4. The system of claim 1, wherein said plant nutrition subsystem comprises a nutrient element disposed alongside said irrigation bladder so as to be wetted by said bladder as it discharges water.

5. The system of claim 1, wherein said deep rooting plant strips provide vertical roots with a tensile strength approximately ⅙^{th} that of comparably sized steel.

6. The system of claim 1, wherein said deep rooting plant strips comprise anchor grass.

7. The system of claim 1, wherein said hydration subsystem, said wattle, and said deep rooting plant strips are physically connected with a common and contiguous biodegradable fabric panel.

8. The system of claim 7, wherein said fabric panel is rolled on a first longitudinal side into a first sleeve defining said elongate wattle, and wherein said elongate wattle contains a composting mulch.

9. The system of claim 8, wherein said fabric panel is rolled on a second longitudinal side into a second sleeve wrapped around and encompassing said irrigation bladder.

10. The system of claim 1, wherein said irrigation bladder comprises at least one elongate permeable irrigation bladder composed of a biodegradable plastic having at least one water inlet.

11. The system of claim 7, wherein said fabric panel is a biodegradable material selected from the group consisting of netting, burlap, and excelsior fiber.

12. The system of claim 7, further including a burrowing animal wire disposed immediately above or below an unrolled flat portion of said fabric panel.

13. The system of claim 1, wherein said mulch wattles are stuffed with a biologically based mulch.

14. The system of claim 13, wherein said biologically based mulch is seeded with micro-organisms to facilitate nutrient release.

15. The system of claim 13, wherein said biologically based mulch is seeded with customized native seed blends for succession planting.

16. The system of claim 1, further including a nutrient rope disposed in or alongside said irrigation bladder.

17. The system of claim 1, wherein said irrigation bladder contains plant nutrient material.

18. The system of claim 1, further including a nutrient sheet disposed underneath said irrigation bladder.

19. The system of claim 1, wherein said irrigation bladder is fabricated from at least one layer of biodegradable permeable film.

20. The system of claim 1, wherein said irrigation bladder, said mulch wattle, and said linear array of deep rooting plant strips are combined with a biodegradable fabric panel, and each of said irrigation bladder, said mulch wattle, and said deep rooting plant strips have a predetermined longitudinal dimension, such that the combination forms a deployment module that may be connected end-to-end in a linear array of modules.

21. The system of claim 20, wherein said irrigation bladders further include a water inlet or water outlet tube such that adjoining irrigation bladders in a linear configuration may be bridged with a jumper hose, further such that filling the irrigation bladders in a linear array can be achieved through a supply hose at the end of a length of joined irrigation bladders.

22. A method of hillside soil erosion reduction, comprising the steps of:
providing a plurality of integrated rapid deployment grass erosion prevention and soil stabilization modules, each of said modules including a fabric panel rolled on one side around an irrigation bladder having a plurality of water outlets, and rolled on a second side to form an elongate mulch wattle spaced slightly apart from the irrigation bladder and disposed in a generally parallel side-by-side relationship in relation to the irrigation bladder so as to form a mulch cradle;
deploying the soil stabilization modules in an end-to-end linear configuration across a hillside; and
placing a generally linear array of deep rooting plant strips on the fabric panel in the mulch cradle between the irrigation bladder and the mulch wattle.

23. The method of claim 22, wherein the grass strips are placed on the mulch cradle before deployment of the soil stabilization modules.

24. The method of claim 22, further including watering in the deep rooting plant strips and thereafter leaving the plants to grow in place without tending, wherein water and nutrients are provided by from the mulch wattle and the irrigation bladder.

25. The method of claim 22, further including providing a nutrient tube or solution for use in connection with the irrigation bladder to provide nutrients to the plant strips.

26. The method of claim 22, further including the step of pre-forming a plurality of soil stabilization modules connected end-to-end for deployment from a spool or pay out from a folded or rolled configuration.
